(19) United States
(12) Patent Application Publication
(10) Pub. No.: US 2026/0285746 A1
(43) Pub. Date: Sep. 24, 2026

(54) PROCESS TO MAKE FREQUENCY SELECTIVE SURFACE

(71) Applicant: AGC GLASS EUROPE, Louvain-la-Neuve (BE)

(72) Inventors: Héloïse ROELANDTS, Gosselies (BE); Laura Ouidade OUANAIM, Gosselies (BE)

(73) Assignee: AGC GLASS EUROPE, Louvain-la-Neuve (BE)

(21) Appl. No.: 19/490,037

(22) PCT Filed: Jul. 8, 2024
(86) PCT No.: PCT/EP2024/069251

§ 371 Date: Dec. 4, 2025

(30) Foreign Application Priority Data
Jul. 27, 2023 (EP) 23188195.4

(51) Int. Cl. C03C 17/32; C03C 17/00; H01Q 15/00

(52) U.S. Cl. CPC C03C 17/32; C03C 17/001; H01Q 15/0013; C03C 2218/119

(57) ABSTRACT

A method for making a micro-scale masking pattern on a substrate through deposition of a shear thinning lacquer where the micro-scale masking pattern includes lines having a
width of at least 30 μm and a width deviation of the lines being at most 35%.

### TECHNICAL FIELD

The present invention relates to a process for making an uncoated fine grid design on a coated surface. The purpose of such a design is to reflect or transmit, completely or partially specific frequencies of the electromagnetic spectrum. Such a design is call a Frequency Selective Surface (FSS). More particularly, the present invention relates to masking part(s) of a substrate's surface before deposition of a coating and removing the mask thanks to water washing later in the process, leaving the designed fine grid FSS pattern.

### BACKGROUND ART

On a coated substrate, it may be desired to provide a non-coated designed area, corresponding to a non-coated data transmission window present on the coated substrate. A Frequency Selective Surface (FSS) is a two-dimensional very fine periodic array on a dielectric substrate. Depending on the array design, the FSS will transmit or reflect, completely or partially specific frequencies of the electromagnetic spectrum, rendering a coated substrate compatible for electromagnetic waves transmission, as for example GSM or GPS. For example, a FSS can be formed on a heated coated windshield (HCWs) to pass specific electromagnetic frequencies while reducing the intensity of hot and cold spots around the uncoated zone. The FSS approach is a good solution to facilitate wireless communication while preserving the thermal performance of a glazing.

Particularly, this invention relates to a method of making any glazing for a vehicle comprising a coated zone and at least one non-coated zone. The coated zone may, for example, have a solar control stack. One should add that the technology presented here in the case of glazing for vehicle may also be suitable for any other applications as for building or furniture.

To reach the uncoated design area, it is known to perform a laser decoating following a precise pattern. For example WO2012066324A1 disclose to perform laser ablation to cut slits in a solar control film. However, this laser decoating involves high investment costs, non-negligible additional logistics and safety aspects. Moreover the design is limited by the laser head window and the cycle time is increased.

U.S. Pat. No. 5,492,750 describes the use of reusable rigid, metal masks positioned over a glass substrate prior to depositing a coating layer so as to provide non-coated portions. Such masks are inconvenient to manipulate, require regular cleaning and are prone to produce an undesirable ghosting effect rather than a clean demarcation between coated and non-coated portions. In addition, the mask is limited to forming one exact pattern and a separate set of masks comprising a number of individual masks for each pattern of coating to be deposited is required for industrial production.

U.S. Pat. No. 5,713,986 describes the use of a water soluble resist material which is applied in a predetermined pattern over a substrate prior to the deposition of a coating layer. This resist material and the overlaying material are dissolved away so as to provide non-coated portions. The dissolution of the resist material requires applying water at high temperature (at least 77° C.) which may be costly when used in a large scale process. The resist material includes substances such as a water soluble film former, a surfactant, a rinsing agent and one or more solvents. The total weight percentage of the film-former, the surfactant and the rinsing agent is generally kept low, thereby providing a resist material which has a substantially low viscosity. When using screen-printing to apply the resist material, it is necessary to add a film thickener to increase the viscosity of the resist material. These film-thickeners may be insoluble in water at high temperature and thus difficult to remove from the substrate. They may react with the resist material and for example may clog the screen used for the printing. They may also have a limited shelf life which requires applying the masking agent within 24 hours after mixing the materials.

U.S. Pat. No. 7,125,462 suggests to provide the substrate with a water soluble ceramic paste as a mask before applying a low-e coating and afterwards removing the mask and the coating thereon by washing with water at a temperature of max 60° C. The mask is applied thanks to a screen mesh of from 70 to 85 and is claimed to be applied at a thickness of 1 to 50 μm to cover a zone. The mask with coating thereon is removed using a conventional line washer with brushes. Using hot water and brushes may cause some damage to the coating.

EP1348674A1 describes a screen printed mask, which is enamel based and can be easily removed by water without the necessity to use a brush. Nevertheless, this process is used to make large bands on a glass substrate and does not require a fine resolution. Testing this solution for the FSS design results in problematic thick lines with spreading of the masking lacquer on the glass, already before entering the coater. This particular process offers interesting advantages but requests some improvements in the case of a fine design.

All previous patent literature explains how to use a mask under a coating and how to get rid together of the mask with the coating. Nevertheless this patent literature mainly concerns large bands or large area of uncoated zones. The problem becomes tricky when facing the necessity to provide a mask which is a grid made of thin lines. None of the previous disclosure mentioned the possibility to use a mask for making micro thin lines that will appear as an uncoated micro thin grid after mask removal. The current processes do not allow to reach the fine design specification required to make a FSS and both the resolution and aesthetic of the FSS produced are poor.

### OBJECT OF THE INVENTION

The objective of the invention is to provide a process for applying a masking pattern on a substrate. The masking pattern comprises a plurality of fine lines having a width as thin as 30 μm, more particularly, the masking pattern comprises plurality of lines comprised between 30 and 300 μm, preferably between 70 and 120 μm. With the current process, the upward limit of the line width is not a technical problem.

The process implies to use a complex composition allowing a clean deposition with a width deviation which is at most 35%, preferably at most 25% and more preferably at most 15%.

Another objective of this invention is that the plurality of lines forms a masking pattern on a substrate. The masking pattern is coated together with the rest of the substrate surface, and afterwards the masking pattern covered by the coating is removed through a water washing, leaving the pattern uncoated on the substrate. Depending the mechanical resistance of the coating, brushes may be used to ease the mask removal.

### SUMMARY OF INVENTION

The invention is using a process close to the process disclosed in EP1348674A1 but a stronger attention has been given to the quality of the lacquer for its composition and its rheological comportment, the invention has also optimize any element that could allow a very low deviation for a thin design. More particularly, the inventors have found that to fulfil all requirements, the lacquer must be a shear thinning lacquer. More particularly the shear thinning lacquer of the invention corresponds to the composition that is given in the table 1.

TABLE 1

| | preferred | More preferred |
|---|---|---|
| Organic solvent (wt %) | 75-85 | 78-82 |
| Organic resin (wt %) | 8-18 | 10-16 |
| Mineral content (wt %) | 3-10 | 4-8 |

According to certain example embodiments, the lacquer of the invention comprises alcoholic solvents like glycol, isopropanol and more preferably the solvent is glycol.

According to certain example embodiments, the organic resin is water soluble, more particularly the resin may be Polyvinylpyrrolidone (PVP).

Both organic parts of the lacquer will contribute to the rheological properties of the lacquer.

This invention concerns a substrate having two main surfaces, one of the main surface is intended to be partly coated with a functional film as for example a film having reflective properties, like a solar control film or a low-e film. Such kind of coatings are very well known by the man in the art and will not be more detailed in this disclosure. Indeed this disclosure is more directed to the uncoated part of the one main surface covered by the functional film. More particularly, this disclosure is directed to a process for making thin uncoated pattern on the one main coated surface. Even more particularly, this disclosure is directed to a process involving a masking design deposited on the one main surface to be coated prior to the deposition of the functional film. Advantageously the substrate may be a glass substrate.

Roughly, the process of the invention comprises the following steps:
a) Cleaning the substrate,
b) Screen printing a mask,
c) Drying the mask,
d) Entering the coater for the functional film (one or more layers) deposition,
e) Washing out the mask and the reflective film deposited on the mask.

To make a micro-scale grid thanks to a masking process, not only the size of the screen is important but also the properties of the paste (or lacquer) that is deposited through the screen.

The present inventors have found that choosing a masking lacquer with specific properties allows to obtain a FSS grid with very fine lines and a very good resolution (low width deviation). More particularly, the main specific properties of the masking lacquer are its viscosity and its rheological comportment. The inventors have also observed that the granulometry of the lacquer may play a role, namely to allow decreasing the line width opening of the screen and increasing the line resolution. The final width and width deviation of the lines (resolution) for the mask design are impacted by the lacquer (see characteristics below), the screen, the squeegee characteristics and by the process itself.

One big advantage of the masking process of the invention is that the FSS grid can be produced simultaneously with the larger uncoated parts, no additional time or substantial costs are added.

The invention is thus focused on the behavior of the masking lacquer from the deposition step up to the coater and even on the decoating step during the washing. For example, it is important to ensure that at the entry of the coater there is no large spreading of the masking lacquer that would result in a larger uncoated area at the end. This is why important parameters as the viscosity and the rheology of the lacquer composition, the screen and the direction of the squeegee for the printing, the drying step after lacquer deposition have been analyzed. This is also important that after the washing no residual marks remains on the coated glass substrate.

According to this invention it is possible to deposit on a substrate a shear thinning lacquer forming very thin lines having a width of at least 30 μm, more particularly, the masking pattern comprises plurality of lines comprised between 30 and 300 μm, preferably between 70 and 120 μm. The width deviation is at most 35%, preferably at most 25% and more preferably at most 15%.

According to this invention, the method involve the deposition of a lacquer wherein said lacquer is characterized by the following:
the n Herschel-Bulkley parameter is lower than 1,
the T₀ Herschel-Bulkley parameter is at least 5,
the K Herschel-Bulkley parameter is at least 5.

According to any embodiment of this invention, the lacquer for the masking has a mineral content which is at least 4 weight %, preferably at least 5 weight % and more preferably at least 6 weight % and which is at most 15 weight %, preferably at most 12 weight % and more preferably at most 10 weight % (wt %).

According to any embodiment of this invention, the granulometry of the lacquer is such that the particles present in the lacquer are characterized by an average particle size which is at most 1 μm.

According to any embodiment of this invention, the lacquer has a composition that allow a rapid drying, a low residual organic content on the substrate, in such a way that it is possible to draw thin width lines and that the mask is easily removed by washing. This particular composition has a volatile organic material in a weight composition that is at least 50%, preferably at least 65% and more preferably at least 80%. By volatile organic material, one should understand the organic part that is removed during the drying process at a temperature which is at least 130° C., preferably at least 150° C. and more preferably at least 165° C. and which is at most 240° C., preferably at most 220° C.

According to any embodiment of this invention, the lacquer, as measured before any manipulation (in the barrel), is characterized by a viscosity comprised between 10000 and 40000 cP, preferably between 12000 and 35000 cP, at a temperature comprised between 20 to 25° C. in a control humidity comprised between 30 and 40%, generally around 35%. The viscosity impacts the deviation of the line width, the spreading, the feasibility to use serigraphy process (necessity to pass through the screen). This particular viscosity allows to deposit the lacquer on the substrate thanks to a screen printing deposition process and it also permits to reach the requested resolution (low width deviation). Avoid spreading to a too large extent is an advantage for the design of micro-scale lines. A higher or lower viscosity may produce inhomogeneous lines and spreading. The viscosity impacts the homogeneity of the line (the resolution of the width) and the spreading. The viscosity must allow the feasibility to use serigraphy process (still need to be able to pass through the screen).

Preferably, according to any embodiment of this invention, after homogenisation, the lacquer is deposited on the screen in an amount sufficient to make the deposition in one pass.

According to any embodiment of this invention, to take advantage of the rheological comportment of the lacquer, the lacquer is screen printed with help of a squeegee having a hardness comprised between 50 and 85, with a pressure of 4 bars to allow the lacquer to pass the screen.

According to any embodiment of this invention, the screen is characterized through a mesh count comprised between 120 and 200, preferably between 160 and 190 and a thread diameter comprised between 25 and 35 μm. Advantageously, the screen is a 180/31. The screen may be any kind of screen compatible with the process of the invention, as for example a silk, nylon, trampoline or polyester screen. Some areas of the screen are blocked to provide the desired pattern (for example fine lines).

According to any embodiment of this invention, the wet thickness (before drying) of the masking pattern is preferably comprised between 2 and 100 μm, preferably between 5 and 30 μm. This thickness is measured with a wet film thickness wheel.

According to any embodiment of this invention, after deposition of the lacquer, the masking pattern is dried. The drying may occur at room temperature with or without pulsed air or by heating the substrate with hot pulsed air or with infra-red lamps or in a heating oven, or by a combination of at least two of these variations. The drying preferably occurs within 5 to 15 minutes, at a temperature which is at least 130° C., preferably at least 150° C. and more preferably at least 165° C. and which is at most 240° C., preferably at most 220° C. The drying of the masking agent enables the evacuation of any volatile substances comprised in the masking agent which could adversely affect the subsequent deposition of the coating film or the resolution of the pattern (low width deviation).

According to any embodiment of this invention, the substrate with the mask is directed to a coater where a functional film is deposited. The functional film may consist of a solar control film and/or an infra-red reflecting film and/or a low emissivity film and/or an anti-reflective film and/or any king of functional layer that may be deposited by a PVD process. The film comprises at least one layer. Such kind of film is very well-known and we will not give any details on it here, nor for the film composition nor for the film deposition process.

According to any embodiment of this invention, after the coating is completed, the masking pattern which is covered by the functional film may be removed from the substrate, so as to provide a portion of the substrate substantially free of the coating film. This removal is made through a simple jet of water which is sufficient to remove the functional film together with the masking material from the masked part of the substrate, leaving an uncoated part of the substrate which correspond to the masking design previously applied. The temperature of the washing water may be the room temperature or a higher temperature. Advantageously the temperature of the water is at most 75° C., preferably at most 60° C. and more preferably at most 50° C. No rubbing, brushing or other related means is necessary for the mask removal, although occasionally, using brushes, depending on the coating, may help.

According to a particular embodiment the invention, the masking pattern is removed by the application of water through one or more nozzles which may be located at a distance of less than 35 cm, preferably at a distance of about 25 cm from the substrate. The water may be applied in one or more steps, for example between one and five steps, preferably in three steps, at the same or different pressures for the one or more steps, the pressure being preferably lower than 120 bars, more preferably lower than 50 bars, most preferably lower than 25 bars. Values of pressure may be, for example between 1, 5, 10, 15, 20, 30, 60 and 100 bars.

According to a particular embodiment the invention, the substrate may undergo a pre-wetting treatment, before the coating removal by application of water, in which a film of water is formed at the surface of the substrate. The pre-wetting treatment is preferably performed at atmospheric pressure. After the pre-wetting treatment, water may be applied at a pressure of, for example, 10 bars in order to remove the majority of the masking pattern covered by the coating film. Water may subsequently be applied at a pressure of, for example, 25 bars in order to remove remaining traces of the masking pattern.

According to another aspect of the invention, after the washing step has been performed, the substrate may be rinsed by application of water and subsequently dried with hot pulsed air, preferably at a temperature lower than 100° C.

According to any embodiment of the invention the water used for the washing step may be tap water, demineralised water, purified water, recycled water or water containing one or more additives. The temperature of the water may be comprised between 10° C. and 100° C., preferably between 15° C. and 75° C.

To allow this simple washing, it is thus important that above all characteristics, the lacquer to be used for this invention, is water washable.

According to an alternative embodiment, the lacquer may be washed with an organic solvent, as for examples, white spirit, acetone, methanol, ethanol, isopropanol, without being exhaustive.

### BRIEF DESCRIPTION OF DRAWINGS

This and other aspects of the present invention will now be described with reference to details discussed below. The following description and drawings are illustrative of the disclosure and are not to be construed as limiting the disclosure. The drawings are not to scale and should not be considered as a limitation of the invention.

FIG. 1 shows the typical viscosity change during the screen printing process.

FIG. 2 is an example of masking pattern

FIG. 3 and FIG. 4 are pictures with the optical microscope showing some of the problems solved by the invention.

FIG. 5 and FIG. 6 are pictures with the optical microscope showing a pattern made with the process of the invention

### DESCRIPTION

### Definitions

Unless otherwise defined, all technical and scientific terms used herein are intended to have the same meaning as commonly understood to one of ordinary skill in the art.

Particularly the Herschel-Buckley model is well known by the man skilled in the art. It simulates shear thinning relationships by raising strain to a power less than one (n<1). The model allows the description of a rheological comportment of a material and the choice of K and T₀ parameters have been made to define the type of lacquer which is convenient for the invention. The n parameter smaller to 1 limit the lacquer of the invention to shear thinning lacquer.

Some terms must be considered as equivalent terms, like for example
Lacquer, paste and masking material: lacquer must be understood as any kind of material with the requested characteristics that may be used to make the masking design of the invention. In such a general meaning, the lacquer of the invention may be an ink, a paint, an enamel, a paste or any kind of composition that fulfil the requested properties for the masking process of the invention. A lacquer is a composition comprising an organic part (resin, solvent) and inorganic residue (frits, pigment for example).
Uncoated or non-coated zone, area, part or portion of a surface all designate the part of the surface of the substrate that is free from any functional film, after mask removal.

In the meaning of the invention, the term width deviation (or deviation) means the inconsistency of the line width of a masking layer that is deposited on the substrate. The width deviation is assessed by measuring the smallest width (sw) and the larger width (lw) of a line, the relative difference (lw−sw)/lw, expressed in % should be at most equal to 35%, preferably at most 25% and more preferably at most 15%. The lower the width deviation will be, the higher the line resolution is.

In the meaning of the invention, the term spreading, means the way the lacquer spread over the substrate before drying. This is a known phenomenon and the man of the art must play with this. For example, using an opening of the screen equal to 100 μm (L_{E}) that result in a line equal to 150 μm (L_{L}) correspond to a spreading(S) of 50% (S=0.50). This can be expressed as follow: L_{L}=L_{E}+S×L_{E}. The width of the opening is adjusted to compensate the spreading. Nevertheless, if the spreading is too high, it can be difficult to manage the opening of the screen because granulometry and or viscosity may be an issue and this could result in an irregular deposition or in some blocking. Practically we have to choose a screen which will fit with the paste characteristics.

In the meaning of the invention, speaking of micro-scale line or grid or whatever, means that the object has a dimension in the micrometre range (1 to 999 μm). Therefor a micro-scale pattern is done with a plurality of micro-scale lines, meaning lines having width in the micrometre range (1 to 999 μm).

The viscosity is measured on a Brookfield RVDV-II+ (10 rpm, spindle S06, 20-25° C. and 30-40% humidity).

The mineral residual content is obtained through a TGA & DSC analysis perform according the norm ISO11358-1:2022 for TGA and ISO11357-1:2016 for DSC. It correspond to the heavy part of the lacquer which remains after complete heating has been performed.

The volatile organic material is the part of the lacquer that is removed under a heating up to 240° C. That is the first weight loss according the TGA & DSC analysis perform according the norm ISO11358-1:2022 for TGA and ISO11357-1:2016 for DSC. This part of the lacquer mainly correspond to solvents. A second part of volatile organic material occurs from 240° C. to 777° C. and corresponds to heavier organic material, mainly corresponding to polymer (resin). The residue is the mineral part of the lacquer.

The average particle size of the particles of the lacquer have been determined through laser diffraction according to the norm ISO13320-1: 1999F. The paste is dissolved in ethanol for dispersion before measuring the size of the particles. The particle size impacts the potential screen design and as a consequence the screen optimization. For instance, it is not possible to increase the mesh count if the granulometry of the lacquer is too high. A too large particle size can be responsible for inhomogeneity of the mask lines and could cause blocking of the screen.

The substrate may be glass, for example a sheet of glass, particularly a sheet of glass intended for subsequent use as or incorporated in an architectural or vehicle glazing panel. It may undergo a thermal toughening treatment or a bending treatment before or after the coating film has been deposited onto at least part of its surface. Alternatively, the substrate may be a rigid or flexible plastics sheet material which may equally be intended for subsequent use as or incorporated in an architectural or vehicle glazing panel. For example, the substrate may be a PET or other plastics sheet material adapted to receive a coating layer and to be laminated or otherwise incorporated in a glazing panel intended for subsequent use as or incorporated in an architectural or vehicle glazing pane. Preferably, the substrate is a soda lime silicate glass.

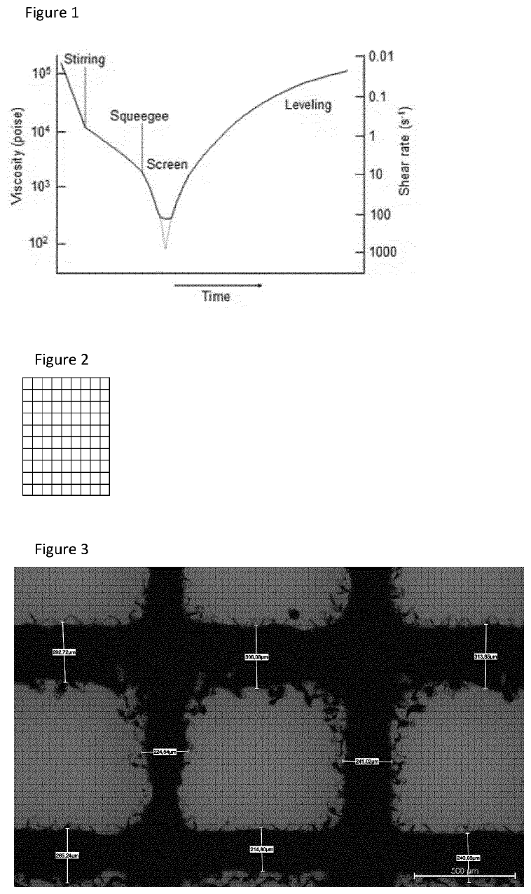

The FIG. 1 illustrates the requested rheological comportment of a shear thinning lacquer, convenient for the process of the invention. The viscosity decreases under shearing and under the stress applied by squeegee, the lacquer pass the screen and then, the lacquer should rebuild. Given values on the figure are illustrating a particular lacquer, those values may different for another lacquer.

Different type of screen may be used. Screen are characterized thanks to a double number separated by a slash. The first number is the mesh count (number of wires per inch) and the second number is the thread diameter (expressed in μm). The emulsion on mesh (EOM) is the third screen characteristic. Those characteristics will define the possible resolution of the lines and must be compatible with the granulometry of the lacquer.

The FIG. 2 is an example of a pattern just for the purpose of illustration.

The FIG. 3 is one example of a poor resolution, meaning important width deviation. The picture is obtained from the optical microscope and illustrates how it is possible to extract a measure from it, e.a. to measure the smaller width (sw) and larger width (lw). The coated glass with the lacquer is prepared and mounted for microscope observation. Before starting the measurement, the optical microscope is calibrated. The objective lens with an appropriate magnification is chosen to observe the coated and non-coated portion clearly and then to capture the image. Using the image analysis software, the width is measured between specifics points accurately. The width is measured at the multiple point to improve accuracy and a mean value is calculated.

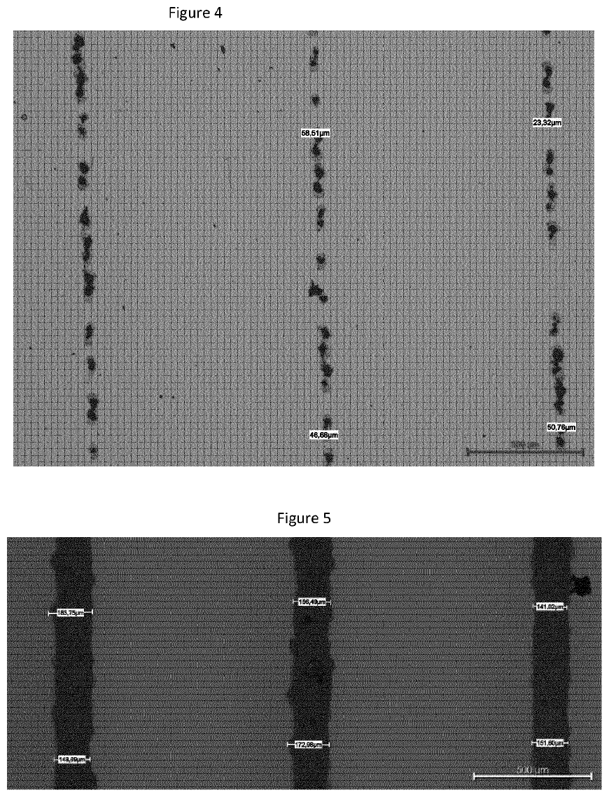

On the FIG. 4 it appears that the lines can have a continuity problem. The source of this issue may be different. This may result from a gravimetric incoherence, or from a blocking of the screen or from a rheological problem of the paste. This is a counter example of what the process of the invention is attempting to get.

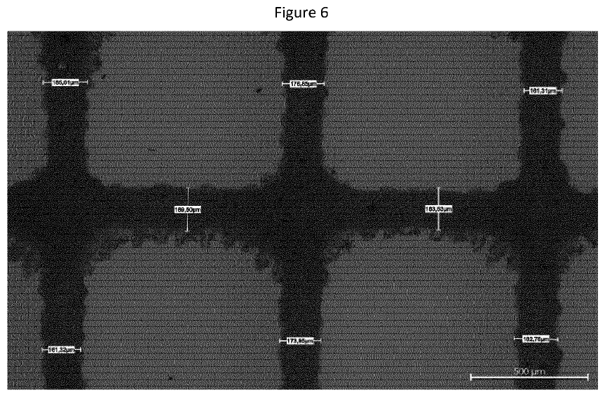

Both FIGS. 5 and 6 are pictures of an example of the invention with very thin lines and a low width deviation.

To summarize the requested characteristics of the masking process, the lacquer must allow good line resolution (low width deviation), a good water washability but must also be compatible with the coater (low outgassing nor creation of defects). Alternatively, washing of the lacquer may be performed with a solvent.

### DESCRIPTION OF EMBODIMENTS/EXAMPLES

The invention will be now illustrated by some examples but one must understand that those examples are by no way limiting the scope of the invention.

For the examples but as a non-limiting embodiment, the raw material used was a 2.1 mm float coating quality glass, having a sample size of 200×200 mm.

As a lacquer, different samples of available materials have been tested for the process. Some characteristics of the material are given in the table 2. As can be seen, amongst the 4 lacquers described in the table 2 only the lacquer B fulfils all requirements, other are thus counter-examples.

TABLE 2
Lacquers characteristics

| | | | | | | Average | |
|---|---|---|---|---|---|---|---|
| | | | | Volatile | Mineral | part. | |
| Lacquer | Herschel-Buckley | | | orga | residue | Size | Viscosity |
| sample | n | T₀ | K | (wt %) | (wt %) | (μm) | (cP) |
| A | 0.83 | 0.67 | 1.47 | 26 | 73 | 3-11 | 8240 |
| B | 0.95 | 12.05 | 12.56 | 80 | 6 | <1* | 23000 |
| C | 1.28 | 4.39 | 1.698 | 22 | 77 | 3-9 | 4240 |
| D | —** | —** | —** | 26 | 72 | 13 | 32000 |

*Average particle size is comprised between 5-50 nm
**The lacquer exhibits a behavior that is closer to Newtonian or behaves like a very low-viscosity fluid, so the Herschel-Bulkley model is not fitting the rheological measurements of the sample D.

The table 3 shows some trials performed on a pilot for the printing and the drying steps. For those trials, the samples were printed with the same design and using the same squeegee. The printing has been performed with a carbon squeegee having a hardness of 85 with a 4 bars pressure. Different screens have been tested. After the deposition of a mask with a thickness of 15 μm, the samples were dried based on the same recipe at a temperature of 170° C. The spreading value, as defined at the paragraph [0045], is given in percent (table 3). The continuity is assessed based on the microscope picture.

The line widths of the printed samples were measured by optical microscope according to the method explained at the paragraph [0055], just after the drying step. For an easier comparison, in the table 3, for the line width, only the mean width value (mw) and the spreading value are given. The continuity column confirm that lines are continue on the substrate: OK means full line continuity and KO means that some breakage are present on the line (see FIG. 4 for KO illustration). Opening is the line opening on the screen, this define the final line width modulated by the spreading value. Finally the water washability of the mask has been assessed (through the washing). We can see that the B lacquer gives good results while other never fulfil all requirements.

TABLE 3
Examples of screen printing

| | | | | | Mean | | | | |
|---|---|---|---|---|---|---|---|---|---|
| | | | | | Line | Spreading | Width | | |
| | | EOM | | Opening | width | value | deviation | | |
| trial | screen | (μm) | Lacquer | (μm) | (μm) | (%) | (%) | continuity | washability |
| 1 | 120/31 | 5 | B | 90 | 195 | 117 | 8.9 | OK | OK |
| 2 | 120/31 | 5 | A | 90 | 360 | 344 | 20 | KO | OK |
| 3 | 120/31 | 5 | C | 90 | 215 | 139 | 32 | KO | OK |
| 4 | 120/31 | 5 | C | 50 | 180 | 1100 | 25 | KO | OK |
| 5 | 120/31 | 5 | D | 90 | 350 | 288 | 16 | OK | OK |
| 6 | 140/31 | 5 | D | 70 | 290 | 314 | 32 | KO | OK |
| 7 | 150/31 | 5 | D | 50 | 220 | 340 | NA* | KO | OK |
| 8 | 180/31 | 10 | B | 40 | 110 | 175 | 5 | OK | OK |

*no deviation measured because line discontinuity is too important

The resolution is still somewhat lower in the direction of the squeegee (parallel to the squeegee) and in cross section points when lines are combined into a grid pattern.

As can be seen (table 3), when conditions are not optimised, when trying to print a line of 90 μm width or below, the resulting printed line is about 195 μm width (trials 1-5). Although the line width could be reduced up to 120 μm with some configurations (pastes A, C and D), this was done to the detriment of the resolution showing important line discontinuities and inhomogeneities. On the other hand for the lacquer B, the line width could be reduced up to 120 μm without any discontinuity nor inhomogeneity. This could be even further decrease with a smaller line opening.

The lacquer B is an hydro soluble commercial composition sold by Ferro under the trade name GSMM MED BLUE TOE8977B2-ME. The inorganic residue comprises mainly Silicate (1-10 wt. %) and the organic part, quite important contains glycol type solvents. Lacquer B has a shear thinning type rheology (see Herschel-Buckley parameters).

Before the washing process is performed, all samples have been directed to a PVD coater where a solar control functional film was deposited on the samples.

In an alternative process, the example of trial 8, after deposition of the mask and of the coating described in paragraph [0067], has been subjected to a washing process using an organic solvent. The coated glass has been rinsed with methanol and all traces of the mask together with the coating deposited above it, has been removed.

1. A method for making a micro-scale masking pattern on a substrate, comprising:
depositing a shear thinning lacquer,
wherein the micro-scale masking pattern comprises lines having a width of at least 30 μm and a width deviation of the lines being at most 35%.

2. The method of claim 1, wherein the width of the lines of the micro-scale masking pattern is from 30 μm to 300 μm.

3. The method of claim 1, wherein the lacquer comprises:
from 75 to 85 weight % of organic solvent,
from 8 to 18 weight % of organic resin, and
from 3 to 10 weight % of mineral residue.

4. The method of claim 1, wherein the lacquer is characterized by
an n Herschel-Bulkley parameter which is lower than 1,
a T₀ Herschel-Bulkley parameter which is at least 5, and
a K Herschel-Bulkley parameter which is at least 5.

5. The method of claim 1, wherein the lacquer has a mineral residual content which is at least 4 weight % and which is at most 15 weight %.

6. The method of claim 1, wherein a granulometry of the lacquer is such that particles present in the lacquer have an average particle size which is at most 1 μm.

7. The method of claim 1, wherein the lacquer has a content of volatile organic material that is at least 50 weight %.

8. The method of claim 1, wherein the lacquer, prior to the depositing, has a viscosity of from 10000 to 40000 cP at a temperature of from 20 to 25° C. and at a humidity of 30 to 40%.

9. The method of claim 1, wherein the lacquer is screen printed onto a surface of the substrate with a squeegee having a hardness of from 50 to 85.

10. The method of claim 1, wherein the lacquer is screen printed onto a surface of the substrate by applying on a squeegee a pressure of 4 bars.

11. The method of claim 1, wherein the lacquer is passed through a screen having a mesh from 120 to 200 μm.

12. The method of claim 1, wherein a wet thickness of the masking pattern is from 2 to 100 μm.

13. The method of claim 1, wherein after depositing the lacquer, the masking pattern is dried within 5 to 15 minutes, at a temperature which is at least 130° C.

14. The method of claim 1, wherein the substrate comprising the masking pattern is coated with a functional film.

15. The method of claim 1, wherein the substrate comprising the masking pattern is coated with a solar control functional film.

16. The method of claim 1, wherein the masking pattern is removed through a water washing process.

17. The method of claim 1, wherein the masking pattern is removed by washing with an organic solvent.

18. The method of claim 1 comprising:
cleaning of the substrate,
screen printing of a mask,
drying the mask,
depositing a functional film, and
washing out the mask together with the functional coating deposited on the mask.

19. The method of claim 1, wherein the width deviation of the lines is at most 15%.

20. The method of claim 1, wherein the lacquer comprises:
from 78 to 82 weight % of organic solvent,
from 10 to 16 weight % of organic resin, and
from 4 to 8 weight % of mineral residue.
